(19) United States
(12) Patent Application Publication
(10) Pub. No.: US 2004/0124696 A1
(43) Pub. Date: Jul. 1, 2004

(54) Dust cup and wheel spindle

(75) Inventor: Ronald Ervin Brunner, Elroy, WI (US)

Correspondence Address: MICHAEL BEST & FRIEDRICH, LLP, 100 E WISCONSIN AVENUE, MILWAUKEE, WI, 53202, US

(73) Assignee: Brunner Drilling and Manufacturing Inc., Mauston, WI (US)

(21) Appl. No.: 10/714,364

(22) Filed: Nov. 14, 2003

Related U.S. Application Data
(60) Provisional application No. 60/427,765, filed on Nov. 20, 2002.

(51) Int. Cl. B60B 37/00

(52) U.S. Cl. 301/124.1

(57) ABSTRACT

A wheel spindle and dust cup assembly comprising a spindle and a dust cup extending radially from the spindle. The dust cup is integrally formed with the spindle from a single shaft and may be formed through a cold forging process. A method of forming a one-piece dust cup and wheel spindle includes the acts of forming a shaft and forming from the material of the shaft a dust cup. The act of forming the dust cup may include the act of cold forging the dust cup. The one-piece design with a cold forged dust cup may completely seal the wheel bearing, retaining grease and preventing debris from entering. The one-piece design eliminates gaps between the dust cup and the wheel spindle so that foreign material cannot enter and grease cannot escape the wheel hub at the junction between the dust cup and the wheel spindle.

### RELATED APPLICATIONS

The present application claims the benefit of prior-filed co-pending provisional patent application Serial No. 60/427,765, filed Nov. 20, 2002.

### FIELD OF THE INVENTION

The present invention relates to wheeled equipment and, more particularly, to a dust cup and wheel spindle and a method of forming the same.

### BACKGROUND OF THE INVENTION

A piece of wheeled equipment, such as an outdoor lawn and garden tractor, generally includes a frame supported by wheels for movement over ground. Typically, the tractor includes a multi-piece assembly for the front wheel axle. The assembly generally includes a machined wheel spindle which supports a front wheel and which connects the front wheel to the front axle and to the steering system. A stamped dust cup is welded to the wheel spindle so that the dust cup covers the wheel bearing when the wheel is supported on the wheel spindle.

### SUMMARY OF THE INVENTION

FIGS. 8-14 illustrate an existing two-piece welded design of a wheel spindle 100 and a dust cup 104 which is welded to the spindle 100. As shown in FIG. 8, the spindle 100 is generally a machined shaft which is bent to the illustrated shape. The spindle 100 has an end 108 which connects to the front axle (not shown) of the tractor (not shown). A bracket 112 is connected to the shaft 100 and connects the shaft 100 to the steering system (not shown) of the tractor. The shaft 100 also has a wheel end 116 on which a front wheel (not shown) is supported. A groove 120 is defined in the wheel end 116, and a retainer clip (not shown) is received in the groove 120 to retain the wheel on the wheel end 116. However, it should be understood that any suitable retainer arrangement may be provided to retain the wheel on the shaft 100.

Before the wheel is positioned on the wheel end 116, the dust cup 104 is positioned on the wheel end 116. The dust cup 104 is then welded (such as at weld 124) to the wheel end 116 to fix the dust cup 104 to the spindle 100. The dust cup 104 is preferably stamped into generally the desired shape (such as that shown in FIG. 12).

The stamping process for producing the dust cup 104 generally has loose tolerances. As a result, when the dust cup 104 is positioned on the spindle 100, gaps may be provided at the junction between the spindle 100 and the dust cup 104. Foreign material and debris may enter the dust cup 104 through such gaps and contaminate the wheel bearing. Also, grease may be lost through such gaps.

The assembly and welding of the dust cup 104 to the spindle 100 also has generally loose tolerances. For example, the dust cup 104 may not be formed or positioned to be concentric with the axis of the shaft 100. Also, during welding, a partial weld on the dust cup 104 (as shown in FIG. 10) can pull the dust cup 104 from a desired position so that the dust cup 104 is not straight and/or not concentric relative to the spindle 100.

In addition, the connecting weld 124 provides a weak point in the existing assembly of the welded dust cup 104 and wheel spindle 100. The weld 124 provides a point of reduced strength between the two components. The weld 124 may break so that the components are no longer connected.

Further, as shown in FIGS. 8-10, the weld 124 is visually unappealing and may appear less durable and of low manufacturing quality to a consumer. Also, the process for assembling the dust cup 104 to the spindle 100 is costly and time consuming and includes the additional step of welding the components.

The present invention provides a dust cup and wheel spindle which substantially alleviates one or more independent problems with the above-described existing two-piece assembly of the welded dust cup 104 and spindle 100 and other such existing assemblies. In some aspects, the present invention provides a one-piece dust cup and wheel spindle. In some aspects, the present invention provides a cold forged dust cup and wheel spindle.

More particularly, in some aspects, the present invention provides a one-piece dust cup and wheel spindle including a shaft having an intermediate portion and a dust cup formed from the material of the shaft on the intermediate portion of the shaft. Preferably, the dust cup is formed by cold forging.

Also, the present invention provides a method of forming a one-piece dust cup and wheel spindle, the method including the acts of forming a shaft having an intermediate portion, and forming from the material of the shaft a dust cup on the intermediate portion of the shaft. Preferably, the act of forming the dust cup includes the act of cold forging the dust cup. In addition, in some aspects, the present invention provides a product made by a process of forming a one-piece dust cup and wheel spindle.

In some aspects, the present invention provides a one-piece design with a cold forged dust cup that will completely seal the wheel bearing, retaining grease and preventing debris from entering. Any gaps between the dust cup and the wheel spindle of the present invention are eliminated so that foreign material cannot enter and grease cannot escape the wheel hub at the junction between the dust cup and the wheel spindle.

Also, in some aspects, the one-piece design of the present invention has increased strength (compared to the existing two-piece welded dust cup 104 and spindle 100). In addition, in some aspects of the present invention, the cold forged dust cup has much tighter tolerances (compared to the stamped dust cup 104), and the tolerances of the one-piece dust cup and the wheel spindle are much closer. These tighter tolerances allow for a tighter fitting wheel.

In some aspects of the present invention, the welding step is eliminated from the process of manufacturing the dust cup and wheel spindle. The cost of manufacturing the one-piece cold forged dust cup and wheel spindle is reduced, and the resulting product is more visually appealing and appears to be (and is) more durable and of a higher manufacturing quality.

Independent features and independent advantages of the present invention will become apparent to those skilled in the art up review of the following detailed description and drawings.

### BRIEF DESCRIPTION OF THE DRAWINGS

FIG. 1 is a perspective view of a dust cup and wheel spindle embodying aspects of the present invention and a portion of a wheel.

FIG. 2 is a perspective view of the inner side of the dust cup and wheel spindle shown in FIG. 1.

FIG. 3 is a perspective view of the dust cup and wheel spindle shown in FIG. 1.

FIG. 4 is a side view of the dust cup and wheel spindle embodying aspects of the present invention.

FIG. 5 is a cross-sectional view taken generally along lines 5-5 in FIG. 4.

FIG. 6 is a perspective view similar to that in FIG. 1 of the dust cup and wheel spindle embodying aspects of the present invention and a portion of the wheel.

FIG. 7 is another perspective view of the dust cup and wheel spindle embodying aspects of the present invention and the wheel.

FIG. 8 is a perspective view of an existing two-piece welded dust cup and wheel spindle.

FIG. 9 is an enlarged view of the existing two-piece welded dust cup and wheel spindle shown in FIG. 8.

FIG. 10 is a further enlarged view of the existing two-piece welded dust cup and wheel spindle shown in FIG. 8.

FIG. 11 is an enlarged perspective view of the inner side of the existing stamped dust cup welded to the wheel spindle as shown in FIG. 8.

FIG. 12 is a perspective view of the inner side of the existing stamped dust cup shown in FIG. 8 before it is welded to the wheel spindle.

FIG. 13 is an inner view of the existing two-piece welded dust cup and wheel spindle.

FIG. 14 is a side view of the existing two-piece welded dust cup and wheel spindle.

Before at least one embodiment of the invention is explained in detail, it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION

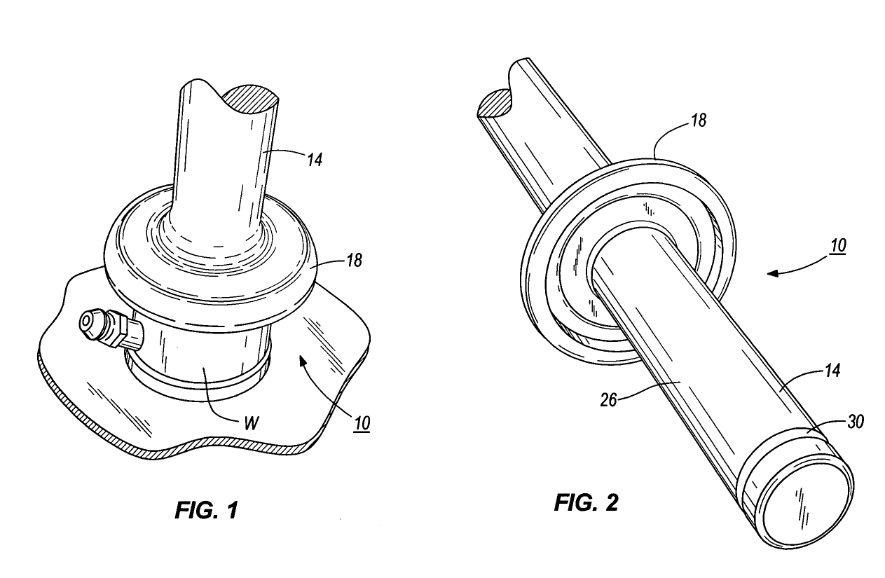

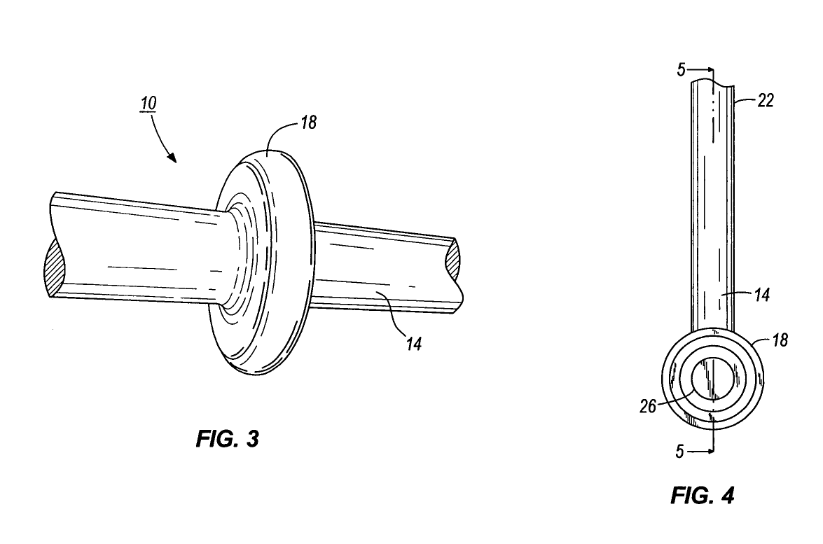

A dust cup and wheel spindle 10 embodying aspects of the invention is illustrated in FIGS. 1-7. In some aspects, the dust cup and wheel spindle 10 is a one-piece component. In some aspects, the dust cup and wheel spindle 10 includes a shaft or wheel spindle 14 and a dust cup 18 which is cold forged from the material of the shaft 14.

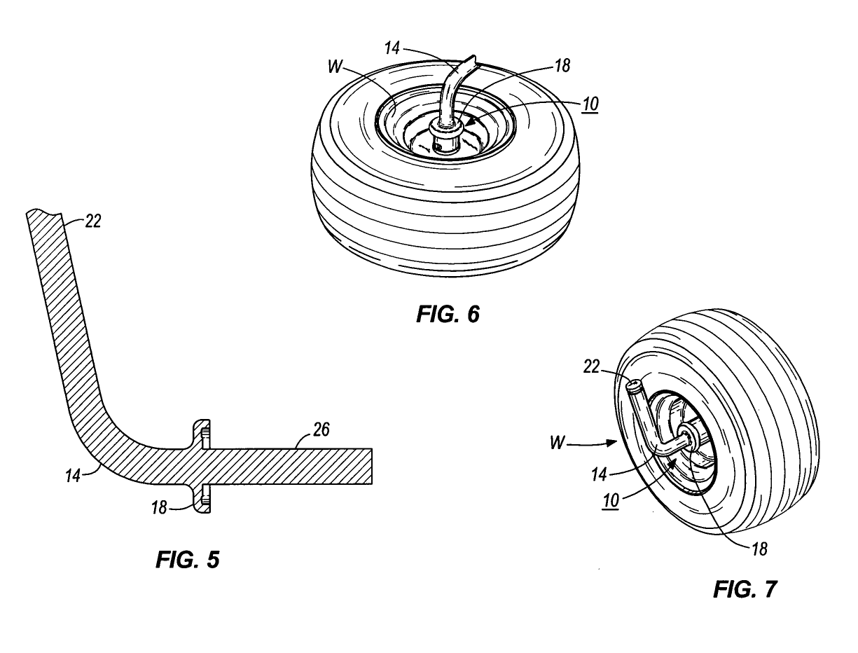

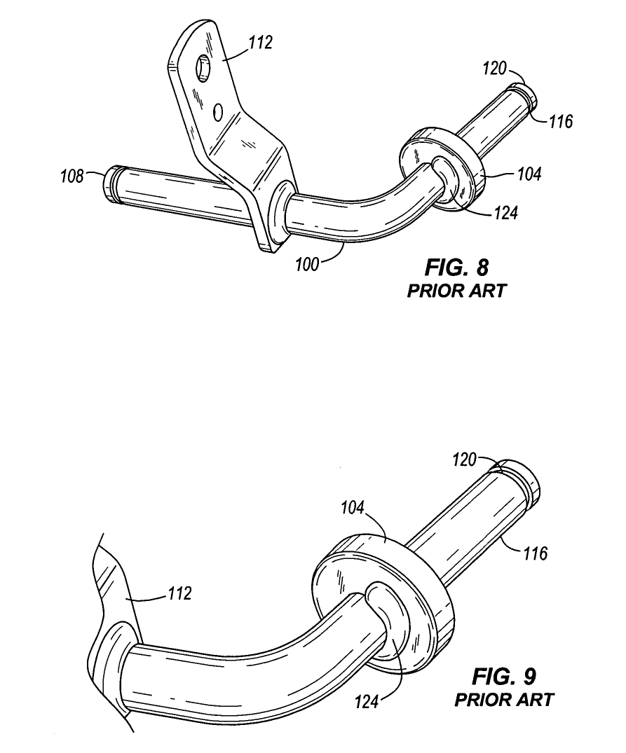

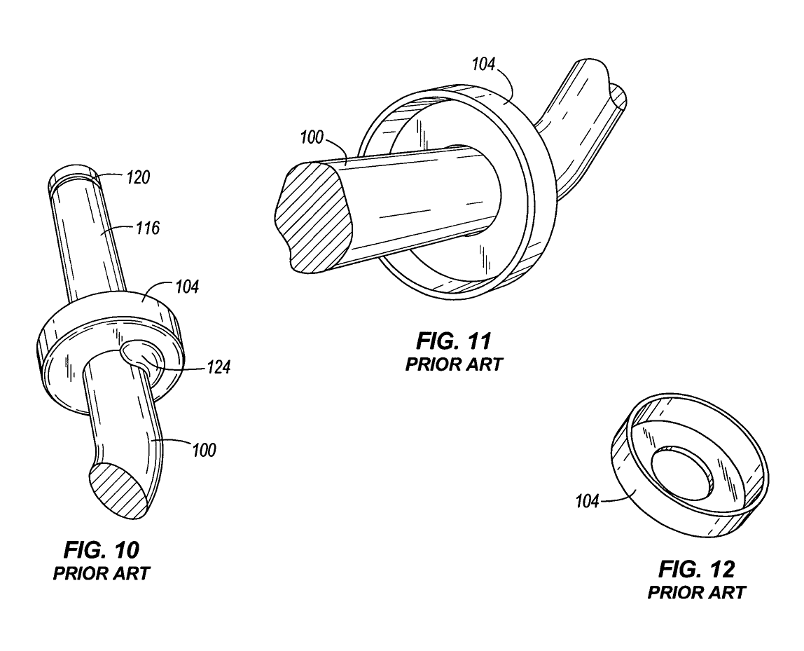

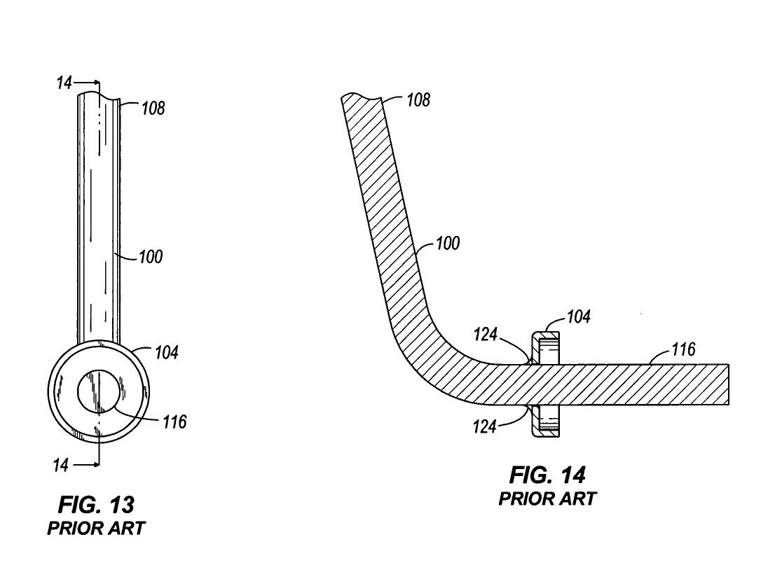

As shown in FIGS. 1 and 6-7, the dust cup and wheel spindle 10 supports a wheel W for a piece of wheeled equipment, such as an outdoor lawn and garden tractor (not shown). The dust cup and wheel spindle 10 may connect the wheel W to the tractor in a manner similar to that illustrated in FIG. 6. Specifically, one end 22 (FIGS. 5-6) of the wheel spindle 14 may connect to the front axle (not shown) of the tractor. A bracket (not shown) may be connected between the wheel spindle 14 and the steering system (not shown) of the tractor. The wheel W is supported on the wheel end 26 (FIGS. 5-6) of the wheel spindle 14, and a retainer clip (not shown) is received in the groove 30 (see FIG. 2) of the wheel end 26 to retain the wheel W on the wheel end 26. The dust cup 18 encloses the wheel bearing, retaining grease and preventing debris from entering.

It should be understood that, in other constructions (not shown), any suitable retainer arrangement may be provided to retain the wheel W on the wheel spindle 14. For example, a threaded or unthreaded hole or recess may be provided in the wheel end 26 of the wheel spindle 14, and a threaded or unthreaded fastner, such as, a screw, a pin, a cotter pin, etc., may be received in the hole to retain the wheel W on the wheel spindle 14.

In some aspects, the dust cup and wheel spindle 10 is generally formed by cold forging the dust cup 18 from the material of the wheel spindle 14. Cold forging is a metal forming process in which metal pieces are plastically shaped to form a final desired shape. The workpiece is generally squeezed between dies under relatively high loads and compressed to the desired shape. Cold forging is generally understood to mean forging the material at room temperature with no heating of the workpiece. Therefore, no microstructural changes occur in the material as a result of the process. However, the workpiece may be annealed at intermediate stages to relieve the effects of work hardening. Cold forging may produce parts with relatively close dimensional tolerances. The size of the work piece may limit the ability to cold forge the component, and most cold forgings weigh less than ten pounds. Complex shapes are difficult to produce using cold forging, and the design of the part may limit the components that may be formed through the process.

The material from which the dust cup and spindle wheel 10 is formed is typically supplied as coil material, and material is drawn off the coil and cut to provide the length of the wheel spindle 14. The dust cup 18 is then cold forged from the material of the wheel spindle 14. The dust cup 18 is formed to have the desired shape and dimensions (such as that illustrated in FIG. 5) required for the use of the dust cup and wheel spindle 10. The wheel spindle 14 is formed to the necessary shape (such as the generally L-shape) for the application.

The dust cup 18 of the dust cup and wheel spindle 10 completely seals the inner bushing and bearing of the wheel W. With the dust cup and wheel spindle 10, any gap between the dust cup 18 and the wheel spindle 14 is eliminated so that foreign material cannot enter into the wheel hub area through the junction between the dust cup 18 and the wheel spindle.

Also, the dust cup and wheel spindle 10 has increased strength (compared to existing two-piece welded dust cup 104 and spindle 100. In addition, the dust cup and wheel spindle 10 embodying aspects of the present invention has tighter tolerances to provide for a tighter fit with the wheel W. There is increased accuracy between the dust cup 18 and wheel spindle 14 so that manufacturing tolerances are reduced at least ten percent.

Further, the dust cup and wheel spindle 10 eliminates the need for the welding step in the manufacturing process. The cost of manufacturing the dust cup and wheel spindle 10 is reduced by about five to ten percent. Also, the dust cup and wheel spindle 10 is more visually appealing and appears to be (and is) more durable and of a higher manufacturing quality.

One or more independent features and independent advantages of the present invention will be set forth in the claims.

I claim:

1. A wheel spindle and dust cup assembly comprising:
a spindle; and
a dust cup extending radially from the spindle and being integrally formed with the spindle, the spindle and dust cup being formed from a single shaft.

2. The wheel spindle and dust cup assembly of claim 1, wherein the shaft has a circumference, the dust cup being continuously joined to the spindle around the circumference of the shaft.

3. The wheel spindle and dust cup assembly of claim 1, wherein the dust cup includes a disc-shaped flange extending radially outwardly from the shaft to an outer edge and a ridge extending from the outer edge of the flange in an axial direction relative to the spindle.

4. The wheel spindle and dust cup assembly of claim 1, further comprising a transition portion at an intersection of the spindle and the dust cup, the transition portion having a radius.

5. A wheel spindle comprising:
a spindle having an axle end connectable to an axle, a wheel end connectable to a wheel, and an intermediate portion defined between the axle end and the wheel end; and
a dust cup extending radially outwardly from the intermediate portion to an outer edge and being integrally formed with the spindle.

6. The wheel spindle of claim 5, wherein spindle includes a bent portion between the axle end and the dust cup.

7. The wheel spindle of claim 5, wherein the shaft has a circumference, the dust cup being continuously joined to the spindle around the circumference of the shaft.

8. The wheel spindle of claim 5, wherein the dust cup includes a disc-shaped flange extending radially outwardly from the spindle to an outer edge and a ridge extending from the outer edge of the flange in a generally axial direction relative to the spindle, the dust cup defining a circular cavity between the ridge and the spindle.

9. The wheel spindle of claim 5, further comprising a transition portion at an intersection of the spindle and the dust cup, the transition portion having a radius.

10. A method of making a wheel spindle and dust cup assembly, the method comprising the acts of:
providing a shaft;
forming from the shaft a spindle having an intermediate portion; and
forming from the shaft a dust cup on the intermediate portion of the spindle.

11. The method of claim 10, wherein the act of forming the dust cup includes the act of cold forging the dust cup from the shaft.

12. The method of claim 10, further comprising the act of bending the shaft to a generally L-shape.

13. The method of claim 10, wherein the act of bending the shaft is performed after the act of forming the dust cup.

14. The method of claim 10, wherein the act of forming the dust cup includes the acts of
forming a disc-shaped flange extending radially outwardly from the shaft to an outer edge, and
forming a ridge extending from the outer edge of the flange in a generally axial direction relative to the spindle.

15. The method of claim 10, wherein the act of forming the dust cup includes the acts of forming a transition portion at the intersection of the spindle and the dust cup, the transition portion having a radius.

16. A wheel spindle made by a process comprising the acts of:
providing a shaft;
forming from the material of the shaft a spindle; and
forming from the material of the shaft a dust cup on the spindle.

17. The wheel spindle of claim 16, wherein the act of forming the dust cup includes the act of cold forging the dust cup from the shaft.

18. The wheel spindle of claim 16, further comprising the act of bending the shaft to a generally L-shape.

19. The wheel spindle of claim 16, wherein the act of bending the shaft is performed after the act of forming the dust cup.

20. The wheel spindle of claim 16, wherein the act of forming the dust cup includes the acts of
forming a disc-shaped flange extending radially outwardly from the shaft to an outer edge, and
forming a ridge extending from the outer edge of the flange in a generally axial direction relative to the spindle.
